(19) United States
(12) Patent Application Publication
(10) Pub. No.: US 2007/0233892 A1
(43) Pub. Date: Oct. 4, 2007

(54) System and method for performing information detection

(75) Inventor: Hiroshi Ueno, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/729,829

(22) Filed: Mar. 30, 2007

(30) Foreign Application Priority Data
Mar. 31, 2006 (JP) 2006-098330

(51) Int. Cl. G06F 15/16

(52) U.S. Cl. 709/231

(57) ABSTRACT

A flow information search section determines whether or not the flow of input data is to be subjected to software processing. If the flow is to be subjected to the software processing, input data is verified by a software processing section. If the flow is not to be subjected to the software processing, a condition determination section determines whether or not the condition for switching to the software processing is satisfied. If the condition is satisfied, the input data is verified by the software processing section, whereas if the condition is not satisfied, the input data is verified by a hardware processing section.

### BACKGROUND OF THE INVENTION

1. Field of the Invention

The present invention relates to a system and a method for performing information detection and, more particularly, to an information detection processing method and apparatus that apply data processing to network traffic to perform information detection for application data.

2. Description of the Related Art

There is available a technique that applies data processing to network traffic to perform information detection for application data. Information detection indicates detection processing of identifying traffic including illegal access, nuisance traffic, virus, and the like from data. There is known a technique that offloads information detection processing from software to hardware in the information detection processing for network packets, to thereby reduce a processing load on the software (refer to Patent Publication PCT-2003-52557A). The technique of this patent publication uses a pre-filtering module that performs pre-processing of firewall processing performed by software.

The pre-filtering module transfers a packet including control information to the firewall processing. The firewall determines whether or not to allow the relevant session to pass therethrough and notifies the pre-filtering module of the result thus determined. When it is determined that the session is allowed to pass, the pre-filtering module performs packet transfer to reduce a load on the firewall processing. The processing that has been offloaded to the pre-filtering module is continued until it receives control information indicating timeout or completion of the entire session.

The technique described in the patent publication as described above is effective for a packet filtering processing of a session such as a TCP/IP session. However, it is difficult to apply a processing such as the processing of the patent publication to an intrusion detection system or a virus detection system that verifies packets on an application layer. This is because a variety of processings corresponding to data formats transferred by detection processing for an application protocol or an application software are required in the intrusion detection processing and, thus, software processing corresponding to the firewall processing of the patent publication cannot determine the transfer state of all the packets after the packet filtering has been enabled. That is, a plurality of points where detailed verification needs to be performed by software spread across a single application session. Thus, data verification only for the leading point is insufficient, disabling offload function to the pre-filtering module.

In performing the data verification for packets on an application layer, not only a simple pattern matching, but also a structural analysis of protocol data, data decoding, or expansion of compressed data needs to be performed before determination of presence/absence of improper data. Such a processing sequence is not uniquely defined in one session, and it is necessary to select processing to be performed based on the structure of application data. Thus, although data verification for packets on an application layer is performed by using the software processing in general, use of only the software processing increases the CPU load, making it difficult to improve the processing performance.

### SUMMARY OF THE INVENTION

It is an object of the present invention to solve the above problems in the conventional technique, and to provide a system and a method for performing information detection processing, which is capable of offloading a part of data verification processing for packets on an application layer to a hardware processing so as to reduce the processing load on the software processing.

The present invention provides a method for detecting information of input data in a flow-by-flow basis, including the steps of: judging whether or not a flow of input data is to be subjected to software processing based on a communication traffic data of an application layer; if it is judged in the judging step that the flow of input data is to be subjected to the software processing, performing information detection of the flow of input data; if it is judged in the judging step that the flow of input data is not to be subjected to the software processing, determining whether or not a condition for switching the flow of input data to the software processing is satisfied based on a content of the flow of input data; if it is determined in the determining step that the condition is satisfied, setting a software processing flag to perform information detection of the flow of input data by using the software processing; and cancelling the setting of the software processing flag to release the flow of input data, upon completion of the information detection using the software processing.

The present invention also provides a system for detecting information of input data in a flow-by-flow basis, including: an input section for receiving a flow of input data; a hardware processing section for performing information detection of the input data by using a hardware processing; a software processing section for performing information detection of the input data by using a software processing; a flow information search section for judging whether or not the flow of input data is to be subjected to the software processing based on flow management data including information indicating a software processing or a hardware processing for each flow of input data; and a condition determination section for specifying the software processing section to perform information detection of the flow of input data if the flow information search section judges that the flow of input data is to be subjected to the software processing, the condition determination section determining whether or not a condition for switching the flow of input data to the software processing is satisfied based on a content of the flow of input data if the flow information search section judges that the flow of input data is not to be subjected to the software processing, the condition determination section indicating the software processing section to perform information detection of the flow of input data if it is judged that the condition is satisfied, the condition determination section indicating the hardware processing section to perform information detection of the flow of input data if it is judged that the condition is not satisfied, the software processing section switching a subsequent processing of the flow of input data to the hardware processing in the flow management data upon completion of the information detection using the software processing.

In accordance with the information detection processing method and system of the present invention, the information detection is switched between the hardware processing and the software processing to perform a suitable information detection processing such that a detailed processing is performed by the software processing whereas a simplified processing is performed by the hardware processing while dividing the session of single application data. Thus reduces the processing load on the software.

### BRIEF DESCRIPTION OF THE DRAWINGS

FIG. 1 is a block diagram showing the configuration of an information detection processing apparatus according to a first embodiment of the present invention;

FIG. 2 is a block diagram showing detailed configurations of the CPU and data processing unit shown in FIG. 1;

FIG. 3A is a block diagram showing detailed configurations of a flow information search section and a condition determination section, FIG. 3B is a table showing a concrete example of a flow management table, and FIG. 3C is a table showing a concrete example of a protocol condition table;

FIG. 4 is a flowchart showing the procedure of operation of the information detection processing apparatus;

FIG. 5 is a view showing a concrete example of input data;

FIG. 6 is a view showing data processed in a first example;

FIG. 7 is a view showing data processed in a second example;

FIG. 8 is a view showing data processed in a third example; and

FIG. 9 is a block diagram showing the configuration of an application data verification processing apparatus according to a second embodiment of the present invention.

### DETAILED DESCRIPTION OF THE PREFERRED EMBODIMENTS

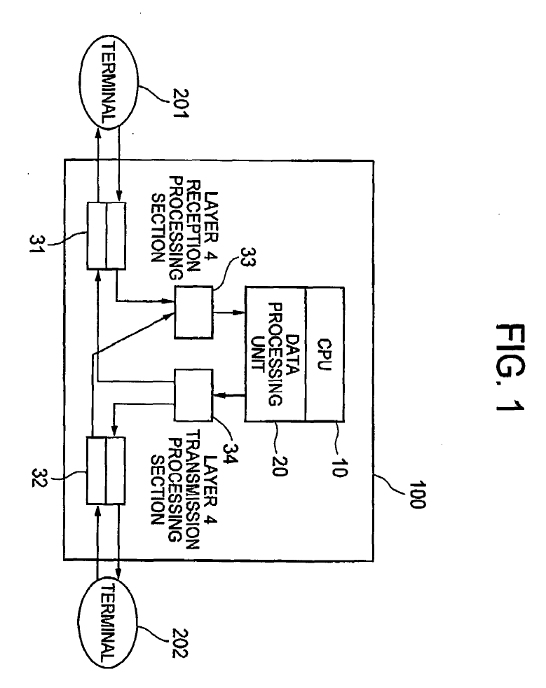

Embodiments of the present invention will be described below with reference to the accompanying drawings, wherein similar constituent elements are designated by similar reference numerals. FIG. 1 shows the configuration of an information detection processing apparatus according to a first embodiment of the present invention. The information detection processing apparatus, generally designated by numeral 100 in FIG. 1, includes a CPU 10, a data processing unit 20, network interfaces 31 and 32, a layer 4 reception processing section 33, and a layer 4 transmission processing section 34. The information detection processing apparatus 100 is used for verifying, at an application layer level, the communication contents transferred between two terminals 201 and 202 connected to paired network interfaces 31 and 32, respectively, provided in the information detection processing apparatus 100.

The terminals 201 and 202 exchange data through the network interfaces 31 and 32 over IP packet-based communication. The network interfaces 31 and 32 each perform packet exchange processing up to layer 3. The layer 4 reception processing section 33 performs termination processing of layer 4 for packets received by the network interfaces 31 and 32. For example, the layer 4 reception processing section 33 performs termination processing of TCP Transmission Control Protocol, RFC793) which is widely used as layer 4 and forwards packet data, of which transmission order has been controlled, to the data processing unit 20. In the case of UDP (User Datagram Protocol, RFC768), the layer 4 reception processing section 33 delivers packet data that has been subjected to processing, such as a checksum calculation, to the data processing unit 20.

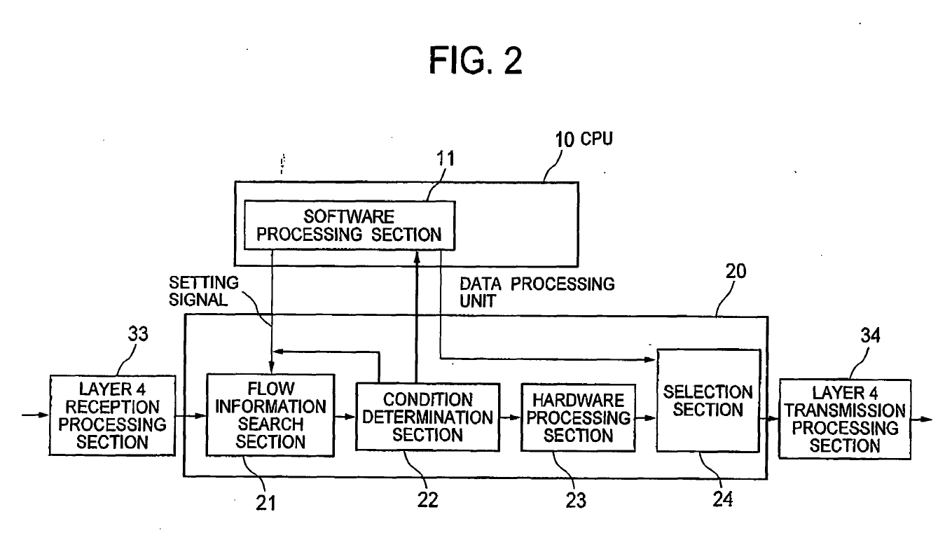

FIG. 2 shows the detailed configuration of the CPU 10 and data processing unit 20 shown in FIG. 1. The CPU 10 includes a software processing section 11. The data processing unit 20 includes a flow information search section 21, a condition determination section 22, a hardware processing section 23, and a selection section 24. The verification for communication contents transferred between the terminals 201 and 202 is performed by the software processing section 11 or hardware processing section 23. The hardware processing section 23 performs data verification processing for input data by means of pattern check or character string search. The software processing section 11 performs data verification processing for the input data by means of pattern check or character string search after performing preprocessing such as determination of proper/improper use of a protocol, decoding of data, or expansion of compressed data. The selection section 24 outputs the data verified by the software processing section 11 or hardware processing section 23 to the layer 4 transmission processing section 34.

The flow information search section 21 performs search processing based on the flow information serving as a unit for identifying an application, to thereby acquire the information indicating whether or not the current flow is to be subjected to software processing by the software processing section 11. The flow information is specified by IP address (transmission source, transmission destination), protocol of layer 4, and port number. More specifically, the flow information is specified by transmission source IP address transmission destination IP address, and TCP port number (of transmission source and destination). The flow taking the opposite direction with respect to these directions is regarded as the same flow.

For example, a packet transmitted in the direction from transmission source (IP1, port number 1) to transmission destination (IP2, port number 2) and a packet transmitted in the direction from transmission source (IP2, port number 2) to transmission destination (IP1, port number 1) are flows talking the opposite directions to each other and yet belonging to the same flow. That is, a set of bi-directional data exchanged between a client and a server in a given application is defined as a single flow. As the information identifying the flow, header information itself can be used, for example. Alternatively, a method may be adopted in which the layer 4 reception processing section 33 is used to identify the flow and an identifier in the apparatus is added for identification of the flow. In the following description, the flow identifier is used for identification of the flow.

If the flow information search section 21 has acquired the information indicating that the current flow is to be subjected to software processing by the software processing section 11, the condition determination section 22 forwards the input data in the current flow to the software processing section 11 for data verification. On the other hand, if the flow information search section 21 has acquired the information indicating that the current flow is not to be subjected to software processing, that is, the current flow is to be subjected to hardware processing by the hardware processing section 23, the condition determination section 22 determines whether or not the condition for switching to data verification by the software processing section 11 is satisfied. When it is determined that the condition is satisfied, the condition determination section 22 delivers the input data to the software processing section 11, whereas when it is determined that the condition is not satisfied, the condition determination section 22 delivers the input data to the hardware processing section 23.

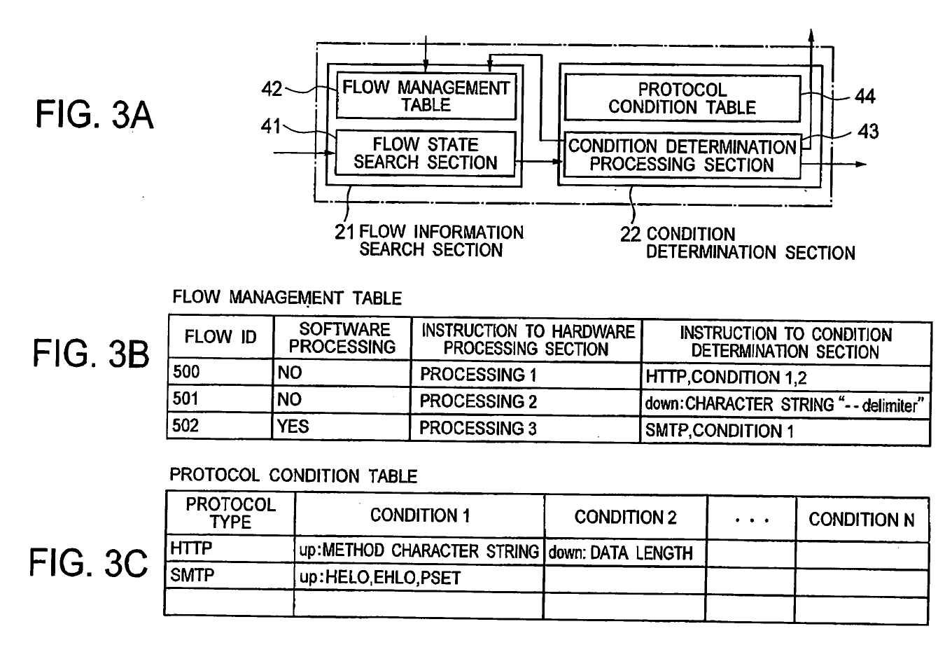

FIG. 3A shows detailed configurations of the flow information search section 21 and condition determination section 22. The flow information search section 21 includes a flow state search section 41 and a flow management table 42. A concrete example of the flow management table 42 is shown in FIG. 3B. The flow management table 42 has, in units of flow identifiers, information indicating whether to select the software processing, instruction information for the hardware processing section 23 if the hardware processing section 23 is used to perform data verification, and instruction information indicating a condition in which hardware processing and software processing are switched over from one to the other by the condition determination section 22. The flow management table 42 stores information depending on individual flows. The flow state search section 41 extracts an entry corresponding to the flow of input data from the flow management table 42.

The condition determination section 22 has a condition determination processing section 43 and a protocol condition table 44. A concrete example of the protocol condition table 44 is shown in FIG. 3C. A plurality of conditions are set for each protocol type in the protocol condition table 44. For example, in the example of FIG. 3C, “up: method character strings” and “down: data length” are set as “condition 1” and “condition 2”, respectively, for an HTTP protocol. These conditions can be set for each protocol not only as fixed data, but also dynamic data provided as, for example, an instruction from the software processing section 11.

The condition determination processing section 43 determines, with respect to a flow which is to be subjected to hardware processing, whether to switch the input data verification by the hardware processing section 23 to that by the software processing section 11 based on the instruction information set in the flow management table 42 (FIG. 3B) to the condition determination section 22 and condition set in the protocol condition table 44.

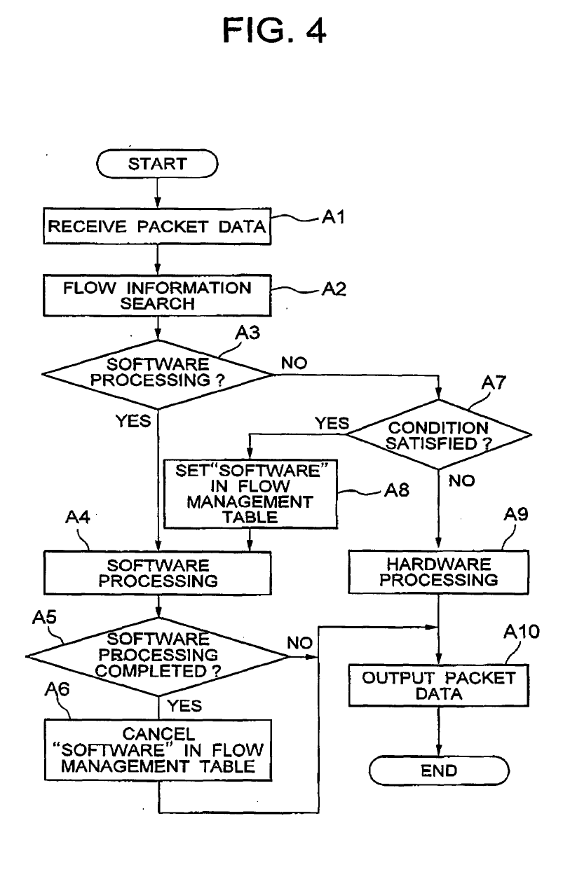

FIG. 4 shows the procedure of operation of the information detection processing apparatus 100. Upon receiving a packet for which layer 4 has been configured from the layer 4 reception processing section 34 (step A1), the flow information search section 21 searches the flow management table 42 for flow information corresponding to the input data (step A2) to acquire information indicating whether or not the current flow is to be subjected to software processing. The condition determination section 22 determines whether or not the flow is to be subjected to software processing (step A3). Upon determining that the flow is to be subjected to the software processing, the condition determination section 22 transfers the input data to the software processing section 11. Upon receiving the input data, the software processing section 11 verifies the received data (step A4).

The software processing section 11 verifies the input data and outputs the verified data to the selection section 24. At this stage, the software processing section 11 determines whether or not data verification has been completed by the software processing (step A5). When it is judged that the data verification has been completed, the software processing section 11 delivers a signal to the flow information search section 21 to allow the flow information search section 21 to set “NO” in the field of “software processing” in the flow management table 42 (FIG. 3B) to cancel a flag, or setting of “software processing=YES” (step A6). Upon determining that the data verification has not been completed, the software processing section 11 does not cancel the setting of “software processing=YES” and continues the data verification.

When verifying traffic data on a protocol such as HTTP or SMTP, the software processing section 11 extracts predetermined information parameters from a command or response data, and then determines that subsequent software processing is unnecessary to cancel the setting of “software processing=YES”. At this stage, if there is an instruction indicating that the subsequent data are to be subjected to hardware processing by the hardware processing section 23, the software processing section 11 writes corresponding content in “instruction information to hardware processing” field of the flow management table 42 (FIG. 3B). For example, if it is not necessary to perform verification for the subsequent data, the software processing section 11 writes instruction information indicating that verification is not necessary for the hardware processing section 23.

Upon canceling the setting of “software processing=YES”, the software processing section 11 updates, according to need, the condition of “instruction information to condition determination section” field in tie flow management table 42 (FIG. 3B) or conditions set in the protocol condition table 44 (FIG. 3C) to thereby set the conditions required for switching the data verification by the hardware processing section 23 to that by the software processing section 11 For example, with respect to an HTTP protocol, if the data body of response data to an HTTP request is processed by tie hardware processing section 23 and followed by switching to the software processing, the software processing section 1I writes “down: data body size” in the protocol condition table 44 so as to switch the hardware processing to the software processing after the set data size has been processed.

When determining in step A3 that the current flow is not to be subjected to the software processing, the condition determination section 22 determines whether or not the condition for switching to the software processing is satisfied (step A7). In this determination processing, the condition determination section 22 determines whether or not the current protocol and direction of flow data correspond to the conditions specified in the flow management table 42 and protocol condition table 44 (FIGS. 3B and 3C). Specifically, the condition determination section 22 searches for a specific character string indicating a command, method, or response of a protocol from the corresponding protocol. More specifically, the condition determination section 22 searches for a character string indicating an HTTP method such as GET or POST, a response character string, or command character string representing a transaction segment in an SMTP protocol. In the protocol condition table 44 shown in FIG. 3C, flow direction (up or down) and character string to be compared are specified as the conditions. These data specify the determination conditions for a command and response.

Upon determining in step A7 that the condition is not satisfied, the condition determination section 22 delivers the input data to the hardware processing section 23. The hardware processing section 23 refers to “instruction information to hardware processing” field in the flow management table 42 and verifies the received data according to the specified instruction (step A9). The data verification performed by the hardware processing section 23 in step A9 is, typically, character string search or pattern matching with a signature performed by hardware. The hardware processing section 23 performs detection of unsolicited mails by means of character string search for a keyword contained in a mail, or detection of hacking or malicious attack through hardware processing. If “verification is not necessary” is specified in “instruction information to hardware processing”, the hardware processing section 23 passes the data therethrough without processing the same.

When determining in step A7 that the condition is satisfied, “software processing=YES” is set as a flag by the condition determination section 22 in the flow management table 42 (step A8). Thereafter, the process shifts to step A4 where the software processing section 11 verifies the input data. The selection section 24 outputs data verified by the software processing section 11 in step A6 or data verified by the hardware processing section 23 in step A9 to the layer 4 transmission processing section 34 (step A10). The layer 4 transmission processing section 34 transmits the data received from the selection section 24 to the terminal 201 or terminal 202.

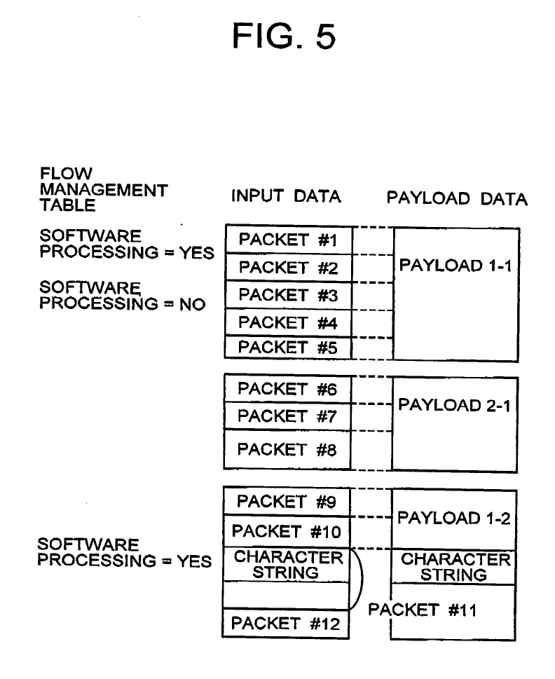

FIG. 5 shows an example of input data. It is assumed here that packets #1 to #12 shown in FIG. 5 are sequentially delivered from the layer 4 reception processing section 33 to the data processing unit 20. In the case of a TCP protocol, the payloads of a corresponding application flow, which are obtained by constructing the input data, are represented as payloads 1-1, 2-1, and 1-2. The payloads 1-1 and 1-2 flow in the same direction. For example, the payloads 1-1 and 1-2 are data payloads from a client to server. The payload 2-1 is data payload from a server to client.

Packet #1 is input to the data processing unit 20 and, if the setting of “software processing=YES” is stored as an initial state for this flow in the flow management table 42, the packet #1 is sent to the software processing section 11 and is then subjected to information detection processing by using the software processing. Subsequently, packet #2 is input to the software processing section 11 and, when it is determined that it is unnecessary to perform the software processing for subsequent packets, the software processing section 11 transmits a predetermined signal to the flow information search section 21 to allow the information search section 21 to set “software processing =NO” for this flow in the flow management table 42.

Since “software processing=NO” is set in the flow management table 42 after packet #2 has been processed, Packet #3 is sent to the hardware processing section 23 after the condition determination processing is performed by the condition determination section 22, and is then subjected to the hardware processing. Likewise, the subsequent packets #4 to #10 are sent to the hardware processing section 23 after the condition determination processing, and are then subjected to data verification by using the hardware processing. Upon detecting that there is a character string, which corresponds to a character string specified by “instruction information to condition determination section” (FIG. 3B) of the flow management table 42, in packet #11, the condition determination section 22 sets “software processing=YES” in the flow management table 42 and delivers packet #11 to the software processing section 11 to thereby switch to the software processing. Packet #12 which follows packet #11 is also subjected to data verification by using the software processing.

As described above, in the present embodiment, whether or not the flow of input data is to be subjected-to software processing is checked with reference to the flow management table 42. If the flow is to be subjected to the software processing, the input data is subjected to data verification by the software processing section 11. If the flow is not to be subjected to software processing, it is determined whether or not the condition for switching to the software processing is satisfied. If the condition is satisfied, switching to the software processing is made and the input data is subjected to data verification by the software processing section 11. If the condition is not satisfied, the input data is subjected to data verification by the hardware processing section 23. With the above configuration, it is possible to dynamically switch between verification by the software processing section 11 and verification by the hardware processing section 23 in a single application session. This allows only a part that needs to be verified in detail to be verified by the software processing and the other part to be offloaded to the hardware processing section 23, thereby preventing a load on the software processing from being increased.

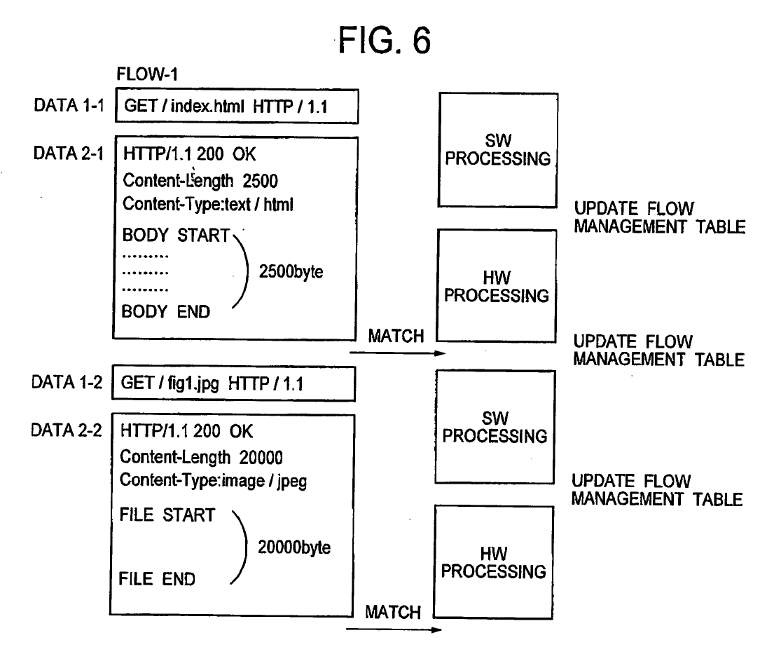

With reference to concrete examples, the present embodiment will be Per described below. FIG. 6 shows data processed in a first example. Network traffic used in the first example is HTTP (Hypertext Transmission Protocol, RFC2616) traffic. Data 1-1, 1-2, in FIG. 6 are command data delivered from a client, and data 2-1, 2-2 are response data delivered from a server. In order to check protocol correctness by using B P command and response data, it is only necessary to check the protocol command and response. On the other hand, in order to search for the segment between data 2-1 and data 2-2, it is necessary to check the contents of data 2-1 and 2-2 so as to acquire the body information thereof, skip reading the data corresponding to the length of the body information, and recognize a null line or consecutive newline characters. In this example, to perform the above processing using the software processing is skipped.

More specifically, data 1-1 is verified in the software processing section 11 and, subsequently, data 2-1 is verified in the software processing section 11. After checking the response character string in the verification of data 2-1, the software processing section 11 determines that it is not necessary to verify the remaining part of data 2-1 by using the software processing and sets “software processing=NO” in the flow management table 42. At this stage, the software processing section 11 acquires the data size (2500 bytes) of the data body of data 2-1 and sets “down: 2500 byte” in the protocol condition table 44 so as to allow data 2-1 to be subjected to the software processing once again after completion of verification for the data body of data 2-1 by the hardware processing section 23. The data size of the data body can be acquired from “Content-Length” line.

The condition determination section 22 determines whether the condition “down: 2500 byte” set by the software processing section 11 is satisfied or not in response data and, at the same time, determines whether a command method character string, such as GET or POST, specified in “instruction information to condition determination section” has been detected in command data. After response data of the data length (2500 byte) has been passed, or data including a command method character string is detected in command data, data 1-2 is verified by the software processing section 11 due to “software processing=YES” being set in the flow management table 42. Similarly, with respect to data 2-2, the software processing section 11 sets “software processing=NO” after verification for the response character string and sets passing of data of 20000 bytes from the start to end of a file as the condition for switching to the software processing so as to allow data 2-2 to be subjected to the software processing once again after completion of verification for the data body of data 2-2 by the hardware processing section 23. This allows only a part that needs -to be verified in detail to be verified by the software processing section 11, and the other part to be verified by the hardware processing section 23.

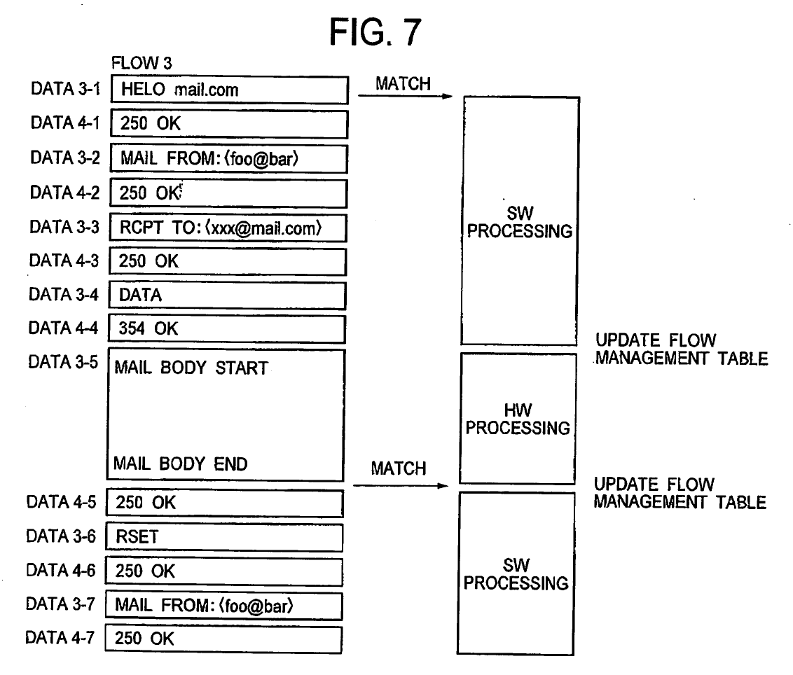

FIG. 7 shows data processed in a second example. Network traffic used in the second example is SMTP (Simple Mail Transfer

Protocol, RFC2821) traffic. Data 3-1 to 3-7 in FIG. 7 are command data delivered from a client, and data 4-1 to 4-7 are response data delivered from a server. In SMTP, a plurality of e-mails can be transmitted in one SMTP session. There are available, at this time, “HELO”, “EHLO”, and “RSET” as commands to start individual mail transactions. In the case of data shown in FIG. 7, the start of a transaction is detected upon the input of data 3-1, and followed by verification by the software processing section 11. Afterward, data 4-1 to 4-4 and data 3-2 to 34 are verified by the software processing section 11.

The software processing section 11 updates the flow management table 42 at the start timing of data 3-5 which corresponds to the mail body to cancel the setting of “software processing=YES”. As a result, data 3-5 is transferred to the hardware processing section 23 and is then verified by the hardware processing. A null character (CR+LF+“. ”+CR+LF, where CR=0×0D, LF=0×0A), which is a character string indicating the end of the mail body, is set as the condition for switching to the software processing in the protocol condition table 44. Upon detecting the null character at the end of data 3-5, the condition determination section 22 updates the flow management table 42 to set “software processing=YES”. As a result, protocol correctness check for the subsequent mail transaction can be performed using the software processing.

The timing at which the software processing section 11 cancels the setting of “software processing=YES” is not limited to data 3-5. For example, the following configuration may be also possible in the determination of unsolicited mails. That is, whether or not a transmission source address indicated by MAIL FROM command in data 3-2 corresponds to a reliable transmission source that has previously been registered is determined and, if they correspond to each other, the setting of “software processing=YES” may be canceled at the time instant of the determination. In this case, data 4-2 and subsequent data are to be verified by the hardware processing section 23, thereby reducing a processing load on the software.

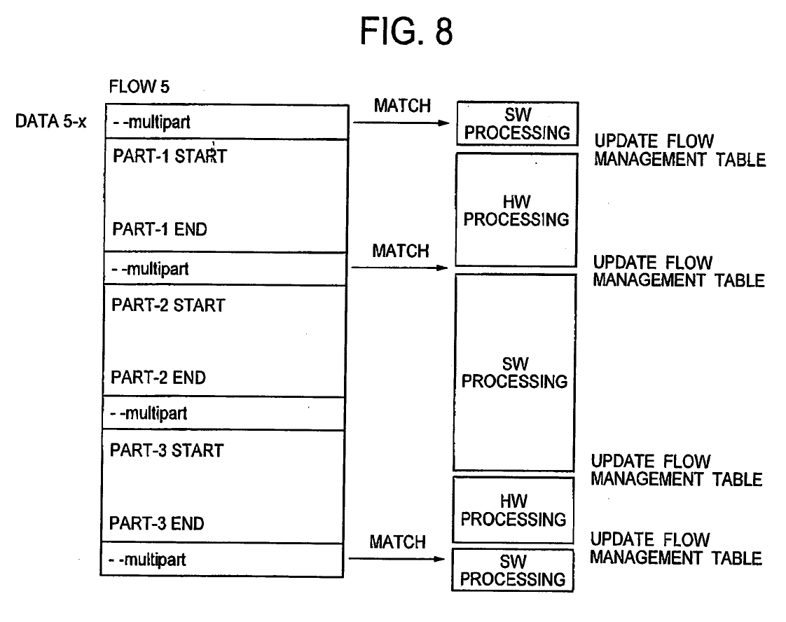

FIG. 8 shows data processed in a third example. In the third example, an e-mail body transferred on an SMUT protocol includes a plurality of types of data according to a format specified by ME (multipurpose internet mail extensions, RFC2045 to 2049). Individual parts are delimited by a character string referred to as delimiter and each include various data types such as text data, image file, and executable file. In FIG. 8, a character string “-multipart” corresponds to the delimiter. Based on the condition registered in the protocol condition table 44, the condition determination section 22 determines that a condition for switching to the software processing has been satisfied when detecting the delimiter.

In FIG. 8, the leading part of the data is verified using the software processing and, thereafter, switching from the software processing to the hardware processing is made in the middle of a first part of the data. Thereafter, if a delimiter delimiting the first part and the second part is detected, switching to the software processing is made. Switching from the software processing to the hardware processing is not made in the second part, and verification for a third part follows in the software processing state.

The switching from the software processing to the hardware processing is made in the middle of the third part, and remaining part of the third part is verified by the hardware processing section 23. When a delimiter is detected at the end of the third part, switching to the software processing is made. As described above, by setting a delimiter character string as the condition for switching to the software processing, it is possible to switch the processing mode depending on the part of the data. That is, the software processing is applied to the leading part of respective parts of the data for detailed verification and the hardware processing is applied to parts in the respective parts for which detailed verification need not be performed. Thus, it is possible to reduce the processing load on software.

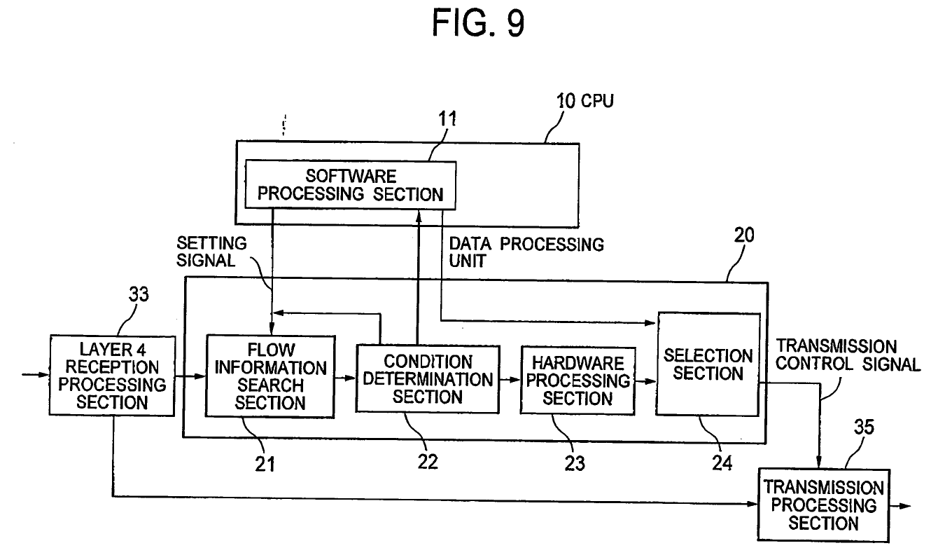

FIG. 9 shows the configuration of an application data verification apparatus according to a second embodiment of the to present invention. The present embodiment is similar to the first embodiment except that the layer 4 reception processing section 33 only monitors a layer 4 protocol and does not terminate communication data between terminals in the present embodiment. The software processing section 11 and hardware processing section 23 deliver a control signal responding to the result of verification for input data to the transmission processing section 35 through the selection section 24. In the present embodiment, the software processing section 11 and hardware processing section 23 perform verification for the data that has been constructed by the layer 4 reception processing and do not perform layer 4 reception processing for the data between terminals. Also in this case, it is possible to perform verification for the input data based on the operation procedure similar to that shown in FIG. 3, thereby obtaining advantages similar to those obtained in the first embodiment.

The condition for switching to the hardware processing after completion of verification using the software processing and the condition for switching to the software processing from verification using the hardware processing depend upon the protocol and data type to be processed. The conditions shown in the above embodiments and examples are merely exemplified and are not to be construed to limit tie present invention.

As described heretofore, in the information detecting system of the present invention, the flow management data may include condition information for judgment whether or not a condition for switching to the software processing is satisfied, and the condition determination section may reference the condition information to judge whether or not the condition for switching to the software processing is satisfied.

The information detecting system of the present invention may include a layer 4 reception processing section for receiving data from a network and performing a layer 4 reception processing to the received data, to deliver the processed data to the input section.

The information detecting system of the present invention may include a layer 4 transmission processing section for performing a layer 4 transmission processing to data after the information detection processing using the software processing section or the hardware processing section, to deliver processed data to a network.

In the information detecting system of the present invention, the condition determination section may judge that the condition is satisfied if a specific keyword is extracted from the flow of input data, the specific keyword being set corresponding to a protocol type of the flow of input data.

In the information detecting system of the present invention, the software processing section may specify, after completion of the software processing, a condition for switching to the software processing based on a content of the flow of input data.

In the information detecting system of the present invention, the condition determination section may determine that the condition for switching to the software processing is satisfied if processing of a data size specified by the software processing section is completed.

In an alternative, the condition determination section may determine that the condition for switching to the software processing is satisfied if a specific character string depending on the flow of input data is extracted, the specific character string being specified by the software processing section.

Although the present invention has been described with reference to the preferred embodiments, the information detection processing method and apparatus according to the present invention are not limited to the above embodiments, and an information detection processing method and an information detection processing apparatus obtained by making various modifications and changes in the configurations of the above-described embodiments will also fall within the scope of the present invention.

What is claimed is:

1. A method for detecting information of input data in a flow-by-flow basis, comprising the steps of:
judging whether or not a flow of input data is to be subjected to software processing based on a communication traffic data of an application layer;
if it is judged in said judging step that said flow of input data is to be subjected to said software processing, performing information detection of said flow of input data;
if it is judged in said judging step that said flow of input data is not to be subjected to said software processing, determining whether or not a condition for switching said flow of input data to said software processing is satisfied based on a content of said flow of input data;
if it is determined in said determining step that said condition is satisfied, setting a software processing flag to perform information detection of said flow of input data by using said software processing; and
cancelling said setting of said software processing flag to release said flow of input data, upon completion of said information detection using said software processing.

2. The method according to claim 1, further comprising the step of performing information detection of said flow of input data by using hardware processing if it is determined in said determining step that said condition is not satisfied, or if a hardware processing instruction is delivered upon said completion of said information detection using said software processing.

3. The method according to claim 1, wherein said determining step determines that said condition is satisfied if a specific keyword is extracted from said flow of input data, said specific keyword being set corresponding to a protocol type of said flow of input data.

4. The method according to claim 2, wherein said software processing specifies, upon completion of said software processing, a condition for switching to said software processing from said hardware processing based on a content of said flow of input data.

5. The method according to claim 4, wherein said determining step determines that said condition for switching to said software processing is satisfied if processing of a data size specified by said software processing is completed in said hardware processing.

6. The method according to claim 4, wherein said determining step determines that said condition for switching to said software processing is satisfied if a specific character string specified by said software processing is extracted.

7. A system for detecting information of input data in a flow-by-flow basis, comprising:
an input section for receiving a flow of input data;
a hardware processing section for performing information detection of said input data by using a hardware processing;
a software processing section for performing information detection of said input data by using a software processing;
a flow information search section for judging whether or not said flow of input data is to be subjected to said software processing based on flow management data including information indicating a software processing or a hardware processing for each flow of input data; and
a condition determination section for specifying said software processing section to perform information detection of said flow of input data if said flow information search section judges that said flow of input data is to be subjected to said software processing, said condition determination section determining whether or not a condition for switching said flow of input data to said software processing is satisfied based on a content of said flow of input data if said flow information search section judges that said flow of input data is not to be subjected to said software processing, said condition determination section indicating said software processing section to perform information detection of said flow of input data if it is judged that said condition is satisfied, said condition determination section indicating said hardware processing section to perform information detection of said flow of input data if it is judged that said condition is not satisfied,
said software processing section switching a subsequent processing of said flow of input data to said hardware processing in said flow management data upon completion of said information detection using said software processing.

8. The system according to claim 7, wherein said flow management data includes condition information for judgment whether or not a condition for switching to said software processing is satisfied, and said condition determination section references said condition information to judge whether or not said condition for switching to said software processing is satisfied.

9. The system according to claim 7, further comprising a layer 4 reception processing section for receiving data from a network and performing a layer 4 reception processing to said received data, to deliver said processed data to said input section.

10. The system according to claim 7, further comprising a layer 4 transmission processing section for performing a layer 4 transmission processing to data after said information detection processing using said software processing section or said hardware processing section, to deliver processed data to a network.

11. The system according to claim 7, wherein said condition determination section judges that said condition is satisfied if a specific keyword is extracted from said flow of input data, said specific keyword being set corresponding to a protocol type of said flow of input data.

12. The system according to claim 7, wherein said software processing section specifies, upon completion of said software processing, a condition for switching to said software processing from said hardware processing based on a content of said flow of input data.

13. The system according to claim 12, wherein said condition determination section determines that said condition for switching to said software processing is satisfied if processing of a data size specified by said software processing section is completed in said hardware processing.

14. The system according to claim 12, wherein said condition determination section determines that said condition for switching to said software processing is satisfied if a specific character string specified by said software processing section is extracted.
